(19) United States
(12) Patent Application Publication
(10) Pub. No.: US 2016/0215555 A1
(43) Pub. Date: Jul. 28, 2016

(54) Sill Assembly for a Threshold System and a Method of Producing the Same

(71) Applicant: Quanex Corporation, Houston, TX (US)

(72) Inventors: James W. Meeks, Eaton, OH (US); Scott M. Fetting, Rice Lake, WI (US)

(21) Appl. No.: 15/004,211

(22) Filed: Jan. 22, 2016

Related U.S. Application Data
(60) Provisional application No. 62/107,049, filed on Jan. 23, 2015.

(51) Int. Cl. E06B 1/70; B29C 47/02

(52) U.S. Cl. CPC E06B 1/70; B29C 47/026; B29K 2075/00

(57) ABSTRACT

A sill assembly is used in a threshold system and includes a sill deck having first and second deck surfaces opposing one another and extending between first and second ends. The sill assembly further includes a sill base formed of a polymer and coupled with the sill deck continuously along the first deck surface between and to the first and second ends of the sill deck for supporting the sill deck between and at the first and second ends. A method of manufacturing the sill assembly includes the steps of providing the sill deck and depositing the polymer to form the sill base coupled with the sill deck along the first deck surface between the first and second ends of the sill deck.

### RELATED APPLICATIONS

This application claims priority to and the benefit of U.S. Provisional Patent Application No. 62/107,049, filed on Jan. 23, 2015, the entire contents of which are hereby incorporated by reference.

### BACKGROUND OF THE INVENTION

1. Field of the Invention

The subject invention relates to a sill assembly for a threshold system and a method of producing the sill assembly.

2. Description of Related Art

Threshold systems are used in entryway systems to seal between a rail of the threshold system and a door panel of the entryway system. The threshold system includes the rail that engages the door panel and a sill assembly that supports the rail. Certain sill assemblies include a sill base and a sill deck. The sill base supports both the rail and the sill deck while the sill deck acts as an aesthetically pleasing transition from the base toward an exterior of a building.

Traditionally, the sill deck is formed of extruded aluminum that is robust enough to withstand loads exerted by a person or an object. The sill base supports the sill deck only in strategic locations that are prone to deformation. The sill base and the sill deck are coupled to one another by mechanical fasteners. These mechanical fasteners are prone to loosening as the loads exerted on the sill deck (such as a person stepping on the sill deck) rotate the sill deck relative to the sill base. Furthermore, the cost of aluminum makes production of the sill base, having thicknesses great enough to support the loads, burdensome on the overall cost of the sill assembly. As such, there remains a need to provide an improved sill assembly.

### SUMMARY OF THE INVENTION AND ADVANTAGES

The subject invention provides for a sill assembly for use in a threshold system, the sill assembly includes a sill deck having first and second deck surfaces opposing one another and extending between first and second ends. The second deck surface is a show surface. The sill assembly further includes a sill base formed of a polymer and coupled with the sill deck continuously along the first deck surface between and to the first and second ends of the sill deck for supporting the sill deck between and at the first and second ends.

The subject invention further provides for a method of manufacturing a sill assembly for use in a threshold system and the sill assembly formed by a process. The sill assembly includes a sill deck having first and second deck surfaces opposing one another and extending between first and second ends, and a sill base formed of a polymer and coupled with the sill deck along the first deck surface between the first and second ends of the sill deck. The method and the process includes the steps of providing the sill deck and depositing the polymer to form the sill base coupled with the sill deck along the first deck surface between the first and second ends of the sill deck.

Accordingly, the sill base coupled with the sill deck continuously along the first deck surface between the first and second ends allows the sill base to fully support the sill deck from a load exerted by an outside source (such as a person stepping on the sill deck) rather than requiring the sill deck to be of increased thicknesses to support itself. By forming the sill assembly using the steps of the method and the process above, the sill deck may be thinner than other sill decks which must be rigid enough to support the load. Furthermore, the depositing of the polymer along the first deck surface of the sill deck promotes improved adhesion between the sill deck and the sill base.

### BRIEF DESCRIPTION OF THE DRAWINGS

Advantages of the subject invention will be readily appreciated as the same becomes better understood by reference to the following detailed description when considered in connection with the accompanying drawings.

FIG. 1 is a perspective view of an entryway system showing a door frame, a door panel, first and second door jambs, and a threshold system.

FIG. 2 is a perspective cross-sectional view of a portion of the threshold system showing a rail and a sill assembly comprising a sill deck and a sill base.

FIG. 3 is a cross-sectional view of the sill assembly.

FIG. 4 is a cross-sectional view of the sill deck in an initial configuration and having a pretreated layer and a structural layer.

FIG. 5 is a cross-sectional view of a portion of the sill deck having the pretreated layer and the structural layer.

FIG. 6 is a cross-sectional view of the sill deck in a modified configuration and having the pretreated layer and the structural layer.

FIG. 7 is a cross-sectional view of the sill deck in the modified configuration and the sill base, with the pretreated layer integral with the structural layer and the sill base.

FIG. 8 is a cross-sectional view of the sill deck and the sill base in a final configuration, with the pretreated layer integral with the structural layer and the sill base.

FIG. 9 is a cross-sectional view of a portion of the sill deck and the sill base with the pretreated layer integral with the structural layer and the sill base.

FIG. 10 is a cross-sectional view of a sill assembly showing a sill deck and a sill base with the sill base defining a dam.

FIG. 11 is a cross-sectional view of a sill assembly showing a sill deck and a sill base with the sill base defining a dam having a greater height that the dam shown in FIG. 10.

FIG. 12 is a cross-sectional view of a sill assembly showing a sill deck, a sill base, and a rail.

### DETAILED DESCRIPTION OF THE INVENTION

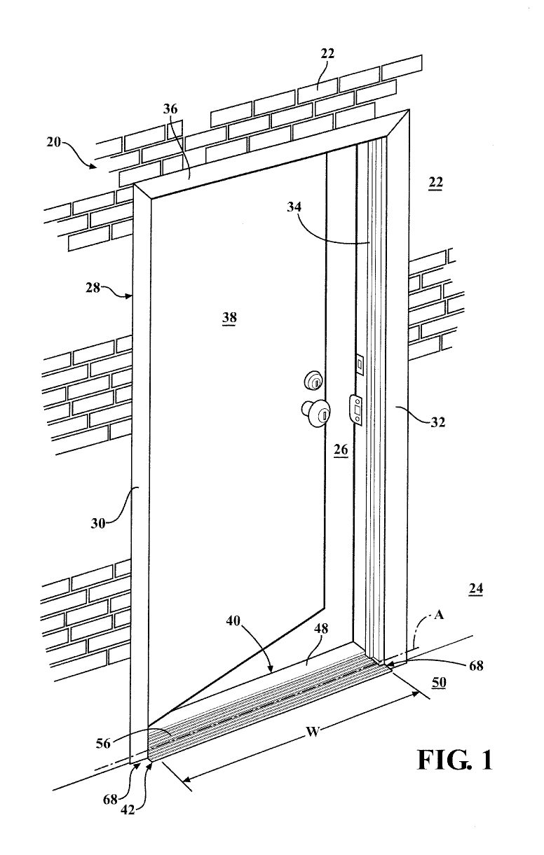

Referring to the Figures, wherein like numerals indicates like or corresponding parts throughout the several views, an entryway system 20 for disposing within an aperture of a structure 22 is generally shown in FIG. 1. The structure 22 is typically a building, such as a commercial or residential building, with the entryway system 20 providing access into the structure 22. The structure 22 defines an exterior 24 and an interior 26. More specifically, the structure 22 has a wall dividing the exterior 24 (outside environment) and the interior 26 of the structure 22. The entryway system 20 is disposed within the aperture to separate the exterior 24 and the interior 26 of the structure 22. Said differently, the exterior 24 and the interior 26 are on opposite sides of the entryway system 20. As such, the entryway system 20 can be used to access the exterior 24 from the interior 26 of the structure 22, and the entryway system 20 can be used to access the interior 26 from the exterior 24 of the structure 22. It is to be appreciated that the entryway system 20 may be utilized in any suitable configuration for providing access through the wall of the structure 22.

The entryway system 20 may include a door frame 28 disposed in the aperture of the structure 22. The door frame 28 typically includes first and second door jambs 30, 32 spaced from each other. The door frame 28 typically defines an opening 34 for providing access between the interior 26 and the exterior 24 of the structure 22. The first and second door jambs 30, 32 are typically substantially parallel to one another. However, it is to be appreciated that the first and second door jambs 30, 32 may be disposed transverse to one another or in any other suitable configuration. The door frame 28 typically includes a door head 36 transverse to and extending between the first and second door jambs 30, 32.

The entryway system 20 may include a door panel 38 coupled to the door frame 28 and capable of moving between an open position (not shown) and a closed position, as shown in FIG. 1. When in the closed position, the door panel 38 is disposed in the opening 34 in the closed position, as shown in FIG. 1. The door panel 38 is typically pivotally coupled to one of the first and second door jambs 30, 32. The door panel 38 is pivotally coupled to the first door jamb 30 in FIG. 1 for exemplary purposes only. The movement of the door panel 38 between the open and closed positions may be further defined as pivoting between the open and closed positions. Said differently, the door panel 38 is hinged to one of the first and second door jambs 30, 32. The door panel 38 is disposed entirely outside of the opening 34 in the open position. The closed position refers to any position of the door panel 38 in which at least a portion of the door panel 38 extends into the opening 34.

As shown in FIG. 1, the entryway system 20 includes a threshold system 40 disposed between the first and second door jambs 30, 32. As shown in FIG. 1, the threshold system 40 is also disposed below the door panel 38 with the door panel 38 contacting the threshold system 40 in the closed position. The threshold system 40 is disposed within the opening 34 opposite the door head 36 and typically extends toward each of the first and second door jambs 30, 32. It is to be appreciated that the threshold system 40 may be disposed anywhere within the opening 34.

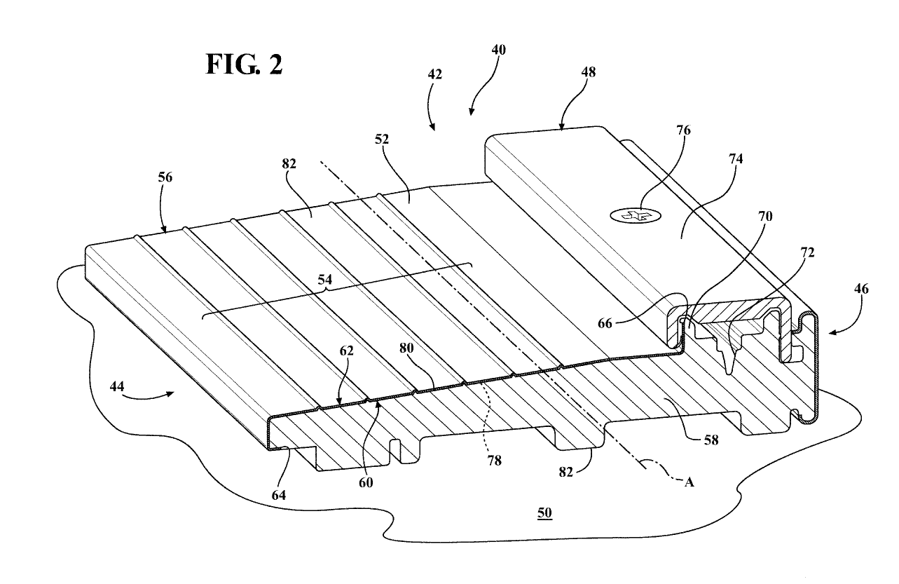

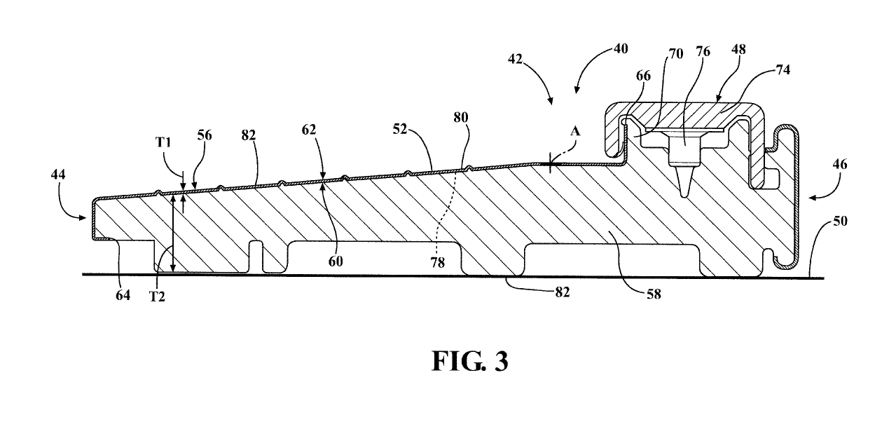

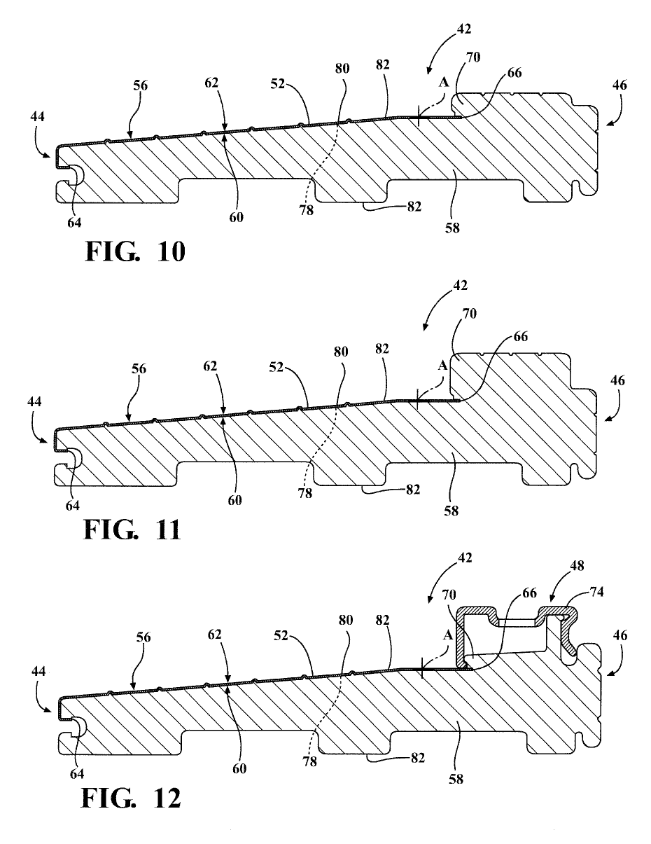

The threshold system 40 includes a sill assembly 42. The threshold assembly may further include a rail 48 as shown in FIGS. 2, 3, and 12. Typically, the sill assembly 42 is positioned along a floor 50 within the opening 34 between the first and second door jambs 30, 32. The rail 48 is typically positioned along and coupled to the sill assembly 42 between the first and second door jambs 30, 32 with the rail 48 configured to engage a bottom of the door panel 38. The rail 48 may be manually-adjustable as shown in FIGS. 2 and 3. Said differently, the rail 48 may be adjusted by a person during installation or servicing toward and away from the door panel 38 to engage the rail 48 with the door panel 38 ensure a proper seal between the rail 48 and the door panel 38. The rail 48 maintains its position relative to the door panel 38 after any adjustment made by the person. Although not shown, the rail 48 may alternatively be self-adjustable. Said differently, the rail 48 may be biased into engagement with the door panel 38 which seals between the rail 48 and the door panel 38. It is to be appreciated that the rail 48 may be positioned anywhere along the sill assembly 42 and may be configured to engage the door panel 38 in any suitable manner. It is also to be appreciated the door panel 38 may include a door sweep (not shown). When present, the rail 48 engages and seals against the door sweep. In another embodiment, as shown in FIGS. 10 and 11, the sill assembly 42 may directly engage the door panel 38. Said differently, the threshold system 40 may lack a rail such that the sill assembly 42 directly engages the door panel 38.

As shown in FIGS. 2 and 3, the sill assembly 42 comprises a sill deck 56 having first and second deck surfaces 60, 62 opposing one another and extending between first and second ends 64, 66. The second deck surface 62 is a show surface. Said differently, the second deck surface 62 is visible upon installation in the sill assembly 42 while the first deck surface 60 is not visible upon installation in the sill assembly 42. The sill assembly 42 further comprises a sill base 58 formed of a polymer. The sill base 58 is coupled with the sill deck 56 continuously along the first deck surface 60 between and to the first and second ends 64, 66 of the sill deck 56 for supporting the sill deck 56 between and at the first and second ends 64, 66. Said differently, the sill base 58 may be coupled with the sill deck 56 along the first deck surface 60 entirely between the first and second ends 64, 66. It is to be appreciated that the sill base 58 may be coupled to the second deck surface 62. For example, as shown in FIGS. 10-12, the sill base 58 extends from the first deck surface 60 around the second end 66 of the sill deck 56 and along a portion of the second deck surface 62.

Typically, the polymer is a foam composite comprising cellular polyvinyl chloride (PVC). It is to be appreciated the polymer may be any suitable material for supporting the sill deck 56.

The sill assembly 42 may extend between an exterior side 44 which faces the exterior 24 of the structure 22 and an interior side 46 which faces the interior 26 of the structure 22. Typically, the first end 64 of the sill deck 56 is positioned at the exterior side 44 of the sill assembly 42 and the second end 66 of the sill deck 56 is positioned toward but spaced from the interior side 46 of the sill assembly 42. As such, the first end 64 of the sill deck 56 defines the exterior side 44 of the sill assembly 42 while the sill base 58 defines the interior side 46 of the sill assembly 42.

As shown in FIG. 1, the sill deck 56 may extend along a longitudinal axis A between a pair of longitudinal ends 68 transverse to the first and second ends 64, 66. As generally illustrated in FIG. 2, the sill base 58 may extend along the first deck surface 60 and be coupled with the sill deck 56 continuously between and to the pair of longitudinal ends 68 (shown in FIG. 1) for supporting the sill deck 56 between and at the pair of longitudinal ends 68. Said differently, the sill base 58 extends between the pair of longitudinal ends 68 without any breaks between the pair of longitudinal ends 68. However, it is to be appreciated that the sill base 58 may be discontinuous (i.e., the sill base 58 may be segmented) between the pair of longitudinal ends 68. Typically, the sill deck 56 extends between the first and second door jambs 30, 32 with the one of the longitudinal ends 68 abutting the first door jamb 30, and the other of the longitudinal ends 68 abutting the second door jamb 32. It is to be appreciated that one or both of the pair of longitudinal ends 68 may be spaced from the first and second door jambs 30, 32. Typically, the sill base 58 extends along and truncates at the longitudinal ends 68 of the sill deck 56 with the longitudinal ends 68 of the sill deck 56 defining a width W of the sill assembly 42, as shown in FIG. 1. It is to be appreciated that the sill base 58 may extend along the sill deck 56, past one or both of the pair of longitudinal ends 68 of the sill deck 56. Furthermore, it is to be appreciated that the sill base 58 may extend along the sill deck 56 and truncate below the sill deck 56 and before the one or both of the pair of longitudinal ends 68 of the sill deck 56. Therefore, the width W of the sill assembly 42 is defined by either or both of the sill deck 56 and sill base 58; i.e., between whichever of the sill deck 56 and the sill base 58 that extends closest to the first door jamb 30 and whichever of the sill deck 56 and the sill base 58 that extends closest to the second door jamb 32.

As shown in FIG. 2, the sill deck 56 may present a tread surface 52 adjacent the exterior side 44 and extending toward the interior side 46. The tread surface 52 is sloped downwardly away from the interior side 46 of the sill assembly 42. The slope of the tread surface 52 promotes drainage of any fluid that may contact the tread surface 52. Said differently, the slope of the tread surface 52 directs the fluid from the threshold system 40 toward the exterior 24 of the structure 22.

The tread surface 52 may also define a plurality of grooves 54 spaced from and parallel to one another, as shown in FIG. 2, and extending along the longitudinal axis A. The grooves 54 collect and direct the fluid, which poses a slipping hazard to a person stepping on the tread surface 52.

As shown in FIG. 3, the sill deck 56 may at least partially define a dam 70 extending upwardly toward the door head 36. More specifically, both of the sill deck 56 and the sill base 58 may define the dam 70. Alternatively, as shown in FIGS. 10-12, the sill base 58 may define the dam 70. The dam 70 prevents backflow of the fluid toward the interior side 46 of the sill assembly 42. As an example, backflow is when the fluid is forced from the exterior side 44 of the sill assembly 42 toward the interior side 46 of the sill assembly 42. Such backflow may occur due to wind forcing the fluid up the tread surface 52.

Although not shown, the dam 70 typically extends along the longitudinal axis A between the first and second door jambs 30, 32. The dam 70 is adjacent to the tread surface 52 and extends away from the tread surface 52 into the opening 34. As such, the dam 70 acts to block backflow of the fluid across the tread surface 52 and into the interior 26 of the structure 22.

The sill deck 56 may have a thickness T1 measured transverse to the longitudinal axis A. The thickness T1 of the sill deck 56 is generally shown in FIG. 3, although it is to be appreciated that the thickness T1 may be measured anywhere between the first and second ends 64, 66. In one embodiment, the thickness T1 is between about 0.010 inches and about 0.050 inches. In another embodiment, the thickness T1 is between about 0.015 inches and about 0.030 inches. In yet another embodiment, the thickness T1 is 0.024 inches. It is to be appreciated that the thickness T1 of the sill deck 56 may be any thickness T1 suitable for positioning along and coupling with the sill base 58.

In addition, the sill base 58 may have a thickness T2 measured transverse to the longitudinal axis A of the sill deck 56. The thickness T2 of the sill base 58 is measured between the sill deck 56 and the floor 50. The thickness T2 of the sill base 58 is generally shown in FIG. 3, although it is to be appreciated that the thickness T2 may be measured anywhere along the sill deck 56 between the first and second ends 64, 66. The thickness T2 of the sill base 58 may vary between the exterior side 44 and the interior side 46 of the sill assembly 42. For example, the sill base 58 may define a plurality of slots defined along the longitudinal axis A between the exterior side 44 and the interior side 46 of the sill assembly 42 and opening toward the floor 50. The thickness T2 of the sill base 58 is typically smaller within the slots than outside of the slots. However, at any position between the first and second ends 64, 66 of the sill deck 56, the sill base 58 is substantially thicker than the adjacent sill deck 56. The term “thicker” means that the thickness T2 of the sill base 58 is greater than the thickness T1 of the sill deck 56. The term “substantially” means that the thickness T2 of the sill base 58 is great enough to support the sill deck 56. Typically, the sill base 58 is considered to be supporting the sill deck 56 when the sill deck 56 minimally deflects when exposed to a load (e.g., a person stepping on the sill deck 56). It is to be appreciated that the thickness T1 of the sill deck 56 and the thickness T2 of the sill base 58 may be any amount and may be any proportion relative to one another that is sufficient for supporting the sill deck 56 with the sill base 58.

As best shown in FIG. 3, the sill base 58 may define a channel 72 defined parallel to the longitudinal axis A of the sill deck 56 and opening toward the door panel 38 when the door panel 38 is in the closed position. The rail 48 is positioned above the channel 72. The rail 48 engages and is coupled with the sill base 58 within the channel 72. For example, when the rail 48 is manually-adjustable as described above and shown in FIG. 3, the rail 48 may include a body 74 and a plurality of screws 76. For exemplary purposes, only one screw 76 is shown in FIGS. 2 and 3. It is to be appreciated that the plurality of screws 76 are typically disposed sequentially along the longitudinal axis A and spaced from one another. The screws 76 extend into the channel 72 and engage the sill base 58. Rotation of the screws 76 in clockwise and counter-clockwise directions causes respective raising of the body 74 toward the door panel 38 and lowering of the body 74 away from the door panel 38. It is to be appreciated that the opposite may be true, i.e., rotation of the screws 76 in clockwise direction may lower the body 74 and rotation of the screws 76 in the counter-clockwise direction may raise the body 74.

As best shown in FIG. 5, the sill deck 56 may have a structural layer defining the first and second deck surfaces 60, 62 and a pretreated layer 78 disposed along at least a portion of the first deck surface 60 for improving the coupling of the sill base 58 with the sill deck 56. Said differently, the pretreated layer 78 improves a bond between the sill deck 56 and the sill base 58, which will be further appreciated below.

The pretreated layer 78 may be disposed entirely along the first deck surface 60. Typically, the pretreated layer 78 is a thin film or coating disposed along the structural layer 80. Furthermore, the structural layer 80 is typically equal-to or between 0.0005 and 0.001 inches thick. The pretreated layer 78 is thinner than the structural layer 80. It is to be appreciated that the pretreated layer 78 and the structural layer 80 may be any thickness. Typically, the structural layer 80 is more rigid than the pretreated layer 78 with the structural layer 80 acting as a plastically-deformable skeleton for the sill deck 56, which allows the sill deck 56 to be worked into different configurations.

The pretreated layer 78 may comprise a polymer. The polymer facilitates improved coupling between the sill deck 56 and the sill base 58. The polymer typically comprises a polyurethane. It is to be appreciated that the pretreated layer 78 may comprise any suitable material.

The structural layer 80 may comprise a metallic material. The metallic material may be at least partially comprised of aluminum. Typically, the metallic material is entirely comprised of aluminum. It is to be appreciated that the metallic material may be a surface-treated aluminum, including but not limited to anodized aluminum. Metallic materials are typically capable of being plastically-deformed, which allows the sill deck 56 to be worked into various configurations and to maintain those configurations. Furthermore, the metallic material is typically capable of preventing penetration of foreign objects (such as fluids like water) through the sill deck 56 to the sill base 58. The metallic material is also more resistant to repeated impacts, rubbing, scratching, etc. (i.e., wear-and-tear) than the sill base 58, which is typically comprised of the polymer. It is to be appreciated that the structural layer 80 may comprise any suitable material.

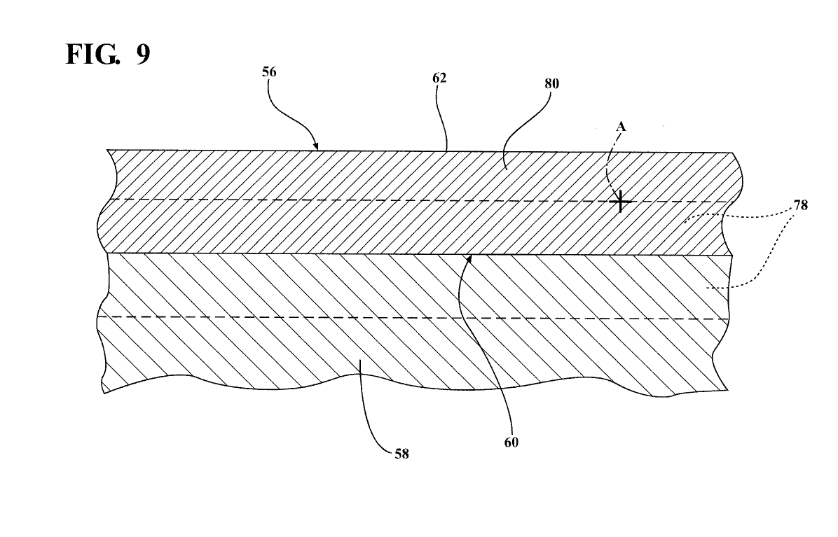

As shown in FIG. 8, the pretreated layer 78 and the structural layer 80 may be integral with one another. Said differently, with the sill base 58 extending along the first deck surface 60 and coupled with of the sill deck 56, the pretreated layer 78 may not be distinguishable from the structural layer 80 of the sill base 58, which is best shown in the magnified view of the coupling of the sill deck 56 and the sill base 58 shown in FIG. 9. Typically, when the sill base 58 is formed along the first deck surface 60 (as will be further described below) the pretreated layer 78 disperses (i.e., extends into and blends with) each of the structural layer 80 and the sill base 58, which improves the coupling between the sill deck 56 and the sill base 58. As such, the pretreated layer 78 and the structural layer 80 may be indistinguishable from one another (i.e., integral).

The invention further comprises a method of manufacturing the sill assembly 42 for use in the threshold system 40. Furthermore, the subject invention also provides for the sill assembly 42 formed by a process. It is to be appreciated that the steps of the method of manufacturing and the process for forming threshold systems 40 are interchangeable. As such, the steps described below are applicable to both the method and the process.

As established above, the sill assembly 42 includes the sill deck 56 having the first and second deck surfaces 60, 62 opposing one another and extending between the first and second ends 64, 66, and the sill base 58 formed of the polymer and coupled with the sill deck 56 along the first deck surface 60 between the first and second ends 64, 6 of the sill deck 56. The method and the process each comprise the steps of providing the sill deck 56 and depositing the polymer to form the sill base 58 coupled with the sill deck 56 along the first deck surface 60 between the first and second ends 64, 66 of the sill deck 56. Said differently, the polymer of the sill base 58 is placed into contact with the first deck surface 60 with the sill deck 56 and the sill base 58 coupling with each other.

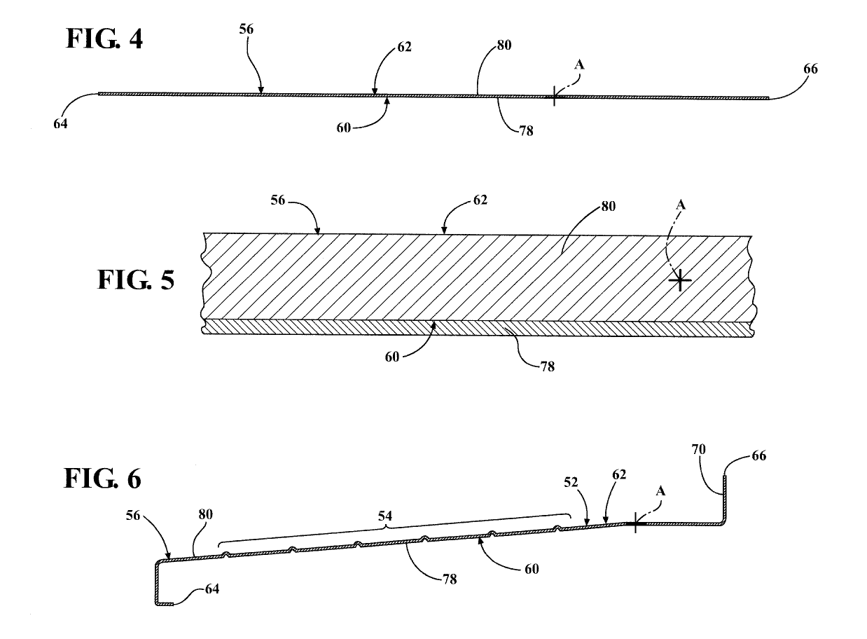

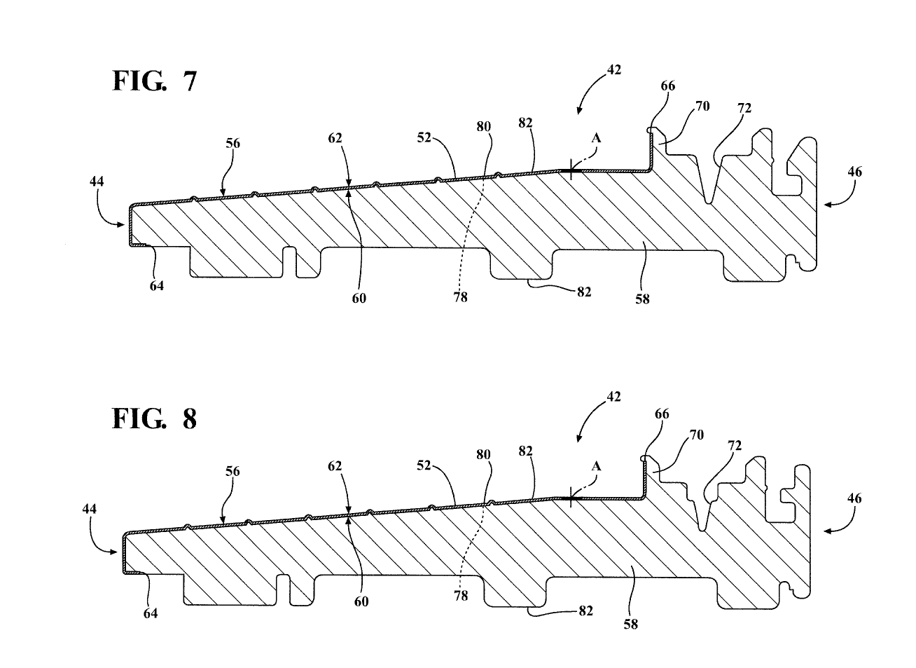

The step of depositing the sill base 58 may be further defined as depositing the polymer to form the sill base 58 coupled with the sill deck 56 continuously along the first deck surface 60 between and to the first and second ends 64, 66 of the sill deck 56. The sill deck 56 prior to the step of depositing the sill base 58 is shown in FIG. 6, while the coupled sill deck 56 and sill base 58 after the step of depositing the sill base 58 is shown in FIG. 7. Additionally, the step of depositing the sill base 58 may be further defined as extruding the sill base 58 formed of the polymer between the first and second ends 64, 66 with the sill base 58 coupled with the sill deck 56 along the first deck surface 60.

During extruding, the sill deck 56 is positioned within a die having an abutment surface and a mold surface. The sill deck 56 engages the abutment surface with the sill deck 56 and the mold surface of the die defining a void. The polymer is extruded into the void, i.e., the polymer material (which is typically in a solid state such as a pellet or granule) is heated by compression or radiant heat to a temperature at or between 300 and 360 degrees Fahrenheit. Typically, the polymer is extruded into the void at between 3,000 to 5,000 pounds per square inch (psi). Furthermore, the polymer takes approximately 10 minutes to transport from an extruder hopper into the void. The polymer is gradually melted by the energy of the compression and/or the radian heat. The molten polymer is then forced into and fills the void. The polymer takes on the shape and the configuration of the void as the polymer cools. It is to be appreciated that the step of depositing the sill base 58 may be performed by any other suitable process, including but not limited to injection molding.

The step of providing the sill deck 56 may be further defined as providing the sill deck 56 having an initial configuration, as shown in FIG. 4. Typically, the initial configuration is a flat and planar configuration. It is to be appreciated that the initial configuration may be any suitable shape, size, composition, etc.

As described above, the sill deck 56 may have the structural layer 80 defining the first and second surfaces 60, 62 and the pretreated layer 78 disposed along at least a portion of the first deck surface 60. The method and the process may each further comprise the step of forming the sill deck 56 of the structural layer 80 and the pretreated layer 78, with the layers 78, 80 best shown in FIG. 5. As described above, typically the structural layer 80 is the metallic material at least partially comprised of aluminum and typically the pretreated layer 78 is the polymer comprised of polyurethane. The method and the process may further include the step of dispersing the pretreated layer 78 into each of the structural layer 80 and the sill base 58 for coupling the sill deck 56 with the sill base 58. As described above, the pretreated layer 78 improves the coupling between the sill deck 56 and the sill base 58 with the pretreated layer 78 and the structural layer 80 integral with one another such that the structural layer 80 and the pretreated layer 78 are indistinguishable. Typically, the step of dispersing the pretreated layer 78 occurs simultaneously with the step of depositing the polymer to form the sill base 58. As such, the pretreated layer 78 and the structural layer 80 are integral after the step of depositing the polymer to form the sill base 58, as shown in FIG. 9. Said differently, the pretreated layer 78 and the structural layer 80 are distinguishable prior to the step depositing the sill base 58.

Typically, the step of forming the sill deck 56 of the structural layer 80 and the pretreated layer 78 occurs prior to the step of providing the sill deck 56. Furthermore, the step of forming the sill deck 56 of the structural layer 80 and the pretreated layer 78 is commonly performed off-site (i.e., not at the same facilities as the steps of providing the sill deck 56 and depositing the polymer to form the sill base 58) and is in-sourced prior to the steps of providing the sill deck 56 and depositing the sill base 58. Typically, the sill deck 56 is in-sourced having the flat configuration and is coiled about an axle. The sill deck 56 is then un-coiled into the planar configuration prior to the step of providing the sill deck 56. It is to be appreciated that the step of forming the sill deck 56 may be performed on-site.

The method and the process may each further comprise the step of working the sill deck 56 into a modified configuration. The sill deck 56 in the initial configuration prior to the step of working the sill deck 56 is shown in FIG. 4, while the sill deck 56 in the modified configuration after the step of working the sill deck 56 is shown in FIG. 6. Typically, the modified configuration is reminiscent of, if not identical to, the configuration of the sill deck 56 in the completed sill assembly 42. Said differently, in the modified configuration, the sill deck 56 has distinguishing features such as the dam 70 and the tread surface 52. It is to be appreciated that the modified configuration may not be a final configuration of the sill deck 56 (i.e., the configuration of the sill deck 56 when the sill deck 56 is part of the completed sill assembly 42) which will be described in greater detail below.

The step of working the sill deck 56 may be further defined as bending the sill deck 56 into the modified configuration. Bending involves the application of force to an object to create a curve or an angle from a flat or straight configuration. Typically, the step of bending the sill deck 56 is further defined as roll-forming the sill deck 56 into the modified configuration. The step of roll-forming typically involves a plurality of roller-dies with the sill deck 56 passing along each of the roller-dies and with each of the roller dies exerting a force on the sill deck 56. The roller-dies progressively bend the sill deck 56 from the initial configuration to the modified configuration. It is to be appreciated that the step of working the sill deck 56 may be performed by any suitable process, including but not limited to forging and extruding.

The method and the process may each further comprise the step of pre-heating the sill deck 56 prior to the step of depositing the polymer to form the sill base 58. The step of pre-heating the sill deck 56 typically follows the step of working the sill deck 56. The step of pre-heating the sill-deck typically involves raising the temperature of the sill deck 56 to approximately 300 degrees Fahrenheit. The step of pre-heating the sill deck 56 improves dispersion of the pretreated layer 78 into the structural layer 80 and into the sill base 58 during the following steps of depositing the polymer to form the sill base 58 and dispersing the pretreated layer 78. It is to be appreciated that the step of pre-heating may involve raising the temperature to any desired temperature.

As described above, the modified configuration may not be the final configuration. It is common that following the step of depositing the sill base 58 (which may occur at or between 300 and 360 degrees Fahrenheit) the polymer of the sill base 58 may not be cooled to a sufficient temperature within the die of the extruder to maintain the shape of the sill base 58 defined by the extruder. Furthermore, the sill deck 56, which also has an elevated temperature, may change size and shape as its temperature decreases after leaving the die of the extruder. As such, the method and the process may each further comprise the step of shaping both the sill deck 56 and the sill base 58 into the final configuration following the step of depositing the polymer to form the sill base 58. The sill deck 56 and the sill base 58 prior to the step of shaping both the sill deck 56 and the sill base 58 into the final configuration is shown in FIG. 7, while the sill deck 56 and the sill base 58 following the step of shaping both the sill deck 56 and the sill base 58 into the final configuration is shown in FIG. 8. The step of shaping the sill deck 56 and the sill base 58 into the final configuration may further comprise the steps applying a vacuum to the sill deck 56 and the sill base 58 within a final die and cooling the sill deck 56 and the sill base 58. The steps of applying the vacuum to the sill deck 56 and the sill base 58 within the final die and cooling the sill deck 56 and the sill base 58 typically occur within a cooling tank. The cooling tank has the final die which has a cross-section that is the same as a cross-section of the final configuration of the sill deck 56 and the sill base 58. The sill deck 56 and the sill base 58 are drawn through the final die which deforms the sill deck 56 and the sill base 58 from the modified configuration to the final configuration. The vacuum is applied to the sill deck 56 and the sill base 58 within the final die to ensure that the sill deck 56 and the sill base 58 are not spaced from an interior surface of the final die.

The step of cooling the sill deck 56 and the sill base 58 may occur simultaneously with step of applying the vacuum to the sill deck 56 and the sill base 58 within the final die and may also occur following the step of applying the vacuum to the sill deck 56 and the sill base 58 within the final die. The step of cooling the sill deck 56 and the sill base 58 typically occurs following the step of applying the vacuum to the sill deck 56 and the sill base 58 within the final die. The step of cooling the sill deck 56 and the sill base 58 involves the application of a fluid (typically water, but may be any suitable fluid) along the sill deck 56 and the sill base 58. The fluid is typically applied directly to an exterior surface 82 of the sill deck 56 and the sill base 58. However, the fluid may be applied indirectly to the exterior surface 82 of the sill deck 56 and the sill base 58 (i.e., the fluid is close to but spaced from exterior surface 82 of the sill deck 56 and the sill base 58). The fluid is heated by the sill deck 56 and the sill base 58 by heat exchange and is transported away from the sill deck 56 and the sill base 58. As such, the fluid cools the sill deck 56 and the sill base 58, which maintains the final configuration of the sill deck 56 and the sill base 58.

Typically, each of the steps described above are performed in succession in accordance with the order described above. Said differently, the steps are performed along a production line with components of the sill assembly 42 being introduced and/or defined progressively along the production line. The steps produce a long continuous sill deck 56 with the sill base 58 being introduced along the production line. The components of the sill assembly 42 must be driven along the assembly line. Therefore, the method and the process may each further comprise the step of pushing the sill deck 56 having the initial configuration along the production line. This step is typically performed prior to the step of depositing the polymer to form the sill base 58. Usually, the coil of the sill deck 56 is driven by the axle. Said differently, the axle rotates which both uncoils the sill deck 56 and pushes the sill deck 56 along the production line. Therefore, the step of pushing the sill deck 56 is typically performed when the sill deck 56 is in the initial configuration shown in FIG. 4.

The step of pushing the sill deck 56 having the initial configuration along the production line may be sufficient to move the sill deck 56 entirely along the production line. However, the forces exerted on the sill deck 56 during the step of depositing the polymer to form the sill base 58 and the potential steps of working the sill deck 56 into the modified configuration and applying the vacuum to the sill deck 56 and the sill base 58 within the final die may apply an opposing force against the force exerted by the driven axle. Therefore, the method and the process may each further comprise the step of pulling the sill deck 56 and the sill base 58 having the final configuration along the production line. This step is typically performed following the step of shaping both the sill deck 56 and the sill base 58 into the final configuration. Usually, a pulling device is positioned down the assembly line following the cooling tank. Therefore, the step of pulling the sill deck 56 is typically performed when the sill deck 56 is in the final configuration shown in FIG. 8. The pulling device grips the sill deck 56 and the sill base 58 having the final configuration coming out of the cooling tank and exerts a force away from the cooling tank. Therefore, the steps of pushing the sill deck 56 and pulling the sill deck 56 and the sill base 58 exert forces acting in the same direction which facilitates movement of the sill deck 56 and the sill base 58 down the production line.

After leaving the cooling tank, the sill deck 56 and the sill base 58 have the final configuration, which is sufficient for use in the sill assembly 42. However, as described above, the sill deck 56 and the sill base 58 are one continuous piece moving along the assembly line. Therefore, the method and the process may each further comprise the step of cutting the sill deck 56 and the sill base 58 to create the sill assembly 42. Said differently, the sill deck 56 and the sill base 58 are cut transverse to the longitudinal axis A such that the sill assembly 42 has the width W as shown in FIG. 1.

By performing these steps, the sill base 58 is continuously coupled with the sill deck 56 between the first and second ends 64, 66, allowing the sill base 58 to fully support the sill deck 56 from a load exerted by an outside source (such as a person stepping on the sill deck) rather than requiring the sill deck 56 to be of increased thicknesses to support itself. By forming the sill assembly 42 using the steps of the process above, the aluminum that is typically used to form the sill deck 56 may be thinner than the aluminum that is used to form other traditional sill decks where the sill deck itself must be rigid enough support the load. Furthermore, the depositing of the polymer along the first deck surface 60 of the sill deck 56 promotes improved adhesion between the sill deck 56 and the sill base 58. Even further, when the pretreated layer 78 is present, the pretreated layer 78 promotes even further adhesion between the sill deck 56 and the sill base 58 by dispersing the pretreated layer 78 into each of the structural layer 80 and the sill base 58.

The invention has been described in an illustrative manner, and it is to be understood that the terminology which has been used is intended to be in the nature of words of description rather than of limitation. As is now apparent to those skilled in the art, many modifications and variations of the subject invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A sill assembly for use in a threshold system, said sill assembly comprising:
a sill deck having first and second deck surfaces opposing one another and extending between first and second ends wherein said second deck surface is a show surface; and
a sill base formed of a polymer and coupled with said sill deck continuously along said first deck surface between and to said first and second ends of said sill deck for supporting said sill deck between and at said first and second ends.

2. The sill assembly as set forth in claim 1 wherein said sill deck has a structural layer defining said first and second deck surfaces and a pretreated layer disposed along at least a portion of said first deck surface for improving said coupling of said sill base with said sill deck.

3. The sill assembly as set forth in claim 2 wherein said pretreated layer is disposed entirely along said first deck surface.

4. The sill assembly as set forth in claim 2 wherein said pretreated layer comprises a polymer.

5. The sill assembly as set forth in claim 4 wherein said polymer comprises a polyurethane.

6. The sill assembly as set forth in claim 2 wherein said structural layer comprises a metallic material.

7. The sill assembly as set forth in claim 6 wherein said metallic material is at least partially comprised of aluminum.

8. The sill assembly as set forth in claim 1 wherein said sill deck extends along a longitudinal axis between a pair of longitudinal ends transverse to said first and second ends with said sill base extending along said first deck surface and coupled with said sill deck continuously between and to said pair of longitudinal ends for supporting said sill deck between and at said pair of longitudinal ends.

9. The sill assembly as set forth in claim 2 wherein said pretreated layer and said structural layer are integral with one another.

10. A method of manufacturing a sill assembly for use in a threshold system, with the sill assembly including a sill deck having first and second deck surfaces opposing one another and extending between first and second ends, and a sill base formed of a polymer and coupled with the sill deck along the first deck surface between the first and second ends of the sill deck; said method comprising the steps of:
providing the sill deck; and
depositing the polymer to form the sill base coupled with the sill deck along the first deck surface between the first and second ends of the sill deck.

11. The method as set forth in claim 10 wherein the step of depositing the sill base is further defined as depositing the polymer to form the sill base coupled with the sill deck continuously along the first deck surface between and to the first and second ends of the sill deck.

12. The method as set forth in claim 10 wherein the step of depositing the sill base is further defined as extruding the sill base formed of the polymer between the first and second ends with the sill base coupled with the sill deck along the first deck surface.

13. The method as set forth in claim 10 wherein the step of providing the sill deck is further defined as providing the sill deck having an initial configuration with said method further including the step of working the sill deck into a modified configuration.

14. The method as set forth in claim 13 wherein the step of working the sill deck is further defined as bending the sill deck into the modified configuration.

15. The method as set forth in claim 10 wherein the sill deck has a structural layer defining the first and second surfaces and a pretreated layer disposed along at least a portion of the first deck surface, further including the step of forming the sill deck of the structural layer and the pretreated layer.

16. The method as set forth in claim 15 further including the step of dispersing the pretreated layer into each of the structural layer and the sill base for coupling the sill deck with the sill base.

17. The method as set forth in claim 10 further including the step of pre-heating the sill deck prior to the step of depositing the polymer to form the sill base.

18. The method as set forth in claim 10 further including the step of shaping both the sill deck and the sill base into a final configuration following the step of depositing the polymer to form the sill base.

19. The method as set forth in claim 18 wherein the step of shaping the sill deck and the sill base into the final configuration further includes the steps applying a vacuum to the sill deck and the sill base within a final die and cooling the sill deck and the sill base.

20. A sill assembly for use in a threshold system, said sill assembly formed by a process and including a sill deck having first and second deck surfaces opposing one another and extending between first and second ends, and a sill base formed of a polymer and coupled with the sill deck along the first deck surface between the first and second ends of the sill deck; the process comprising the steps of:
providing the sill deck; and
depositing the polymer to form the sill base coupled with the sill deck along the first deck surface between the first and second ends of the sill deck.
